(19) United States
(12) Patent Application Publication
(10) Pub. No.: US 2025/0135632 A1
(43) Pub. Date: May 1, 2025

(54) ARM PORTION FOR A ROBOT ARM, ARM PART FOR A ROBOT ARM, AND ROBOT ARM

(71) Applicant: NEURA ROBOTICS GMBH, Metzingen (DE)

(72) Inventors: Josef EZECHIAS, Herrenberg (DE); Jan BUEHLER, Eningen (DE); Jannik GOEZ, Albstadt (DE); David REGER, Metzingen (DE)

(21) Appl. No.: 18/834,943

(22) PCT Filed: Jan. 31, 2023
(86) PCT No.: PCT/EP2023/052306

§ 371 Date: Jul. 31, 2024

(30) Foreign Application Priority Data
Feb. 1, 2022 (DE) 102022102347.8

(51) Int. Cl. B25J 9/00

(52) U.S. Cl. CPC B25J 9/0009

(57) ABSTRACT

An arm portion for a robot arm with a portion longitudinal axis has at least one gear motor for actuating the arm portion. The gear motor has a motor, a transmission, and a gear motor housing. A supporting structure is formed at least in portions exclusively by the gear motor housing along the portion longitudinal axis in the region of the gear motor housing. A robot arm has a first arm portion with a first portion longitudinal axis and a first gear motor, and a second arm portion having a second portion longitudinal axis and a second gear motor and adjoins the first arm portion. The second arm portion is mounted relative to the first arm portion so as to be rotatable about an articulation axis arranged with an angular offset from the first portion longitudinal axis and the second portion longitudinal axis.

The invention relates to an arm portion for a robot arm, an arm part for a robot arm, and a robot arm.

For robots, especially for collaborative robots and for cognitive robots, broad areas of application in industry, assembly, kitchen, massage, screening, hotels, nursing home, household and service are continuously being tested and developed.

Collaborative and cognitive robots typically work and cooperate with humans without protective means such as, for example, enclosure. Particularly high safety requirements are therefore placed on such robots in order to exclude the risk of injury to humans. Such robots are often designed as one-armed robots that have one robot arm.

According to the current prior art such robot arms are edgy and angular and very wide in the region of rotary axes about which different arm portions are mounted relative to each other. This results in a larger installation space, and therefore inevitably more disruptive surface for possible contact with humans and thus also a greater risk of injury.

Such robot arms are known, for example, from EP 3 572 192 B1, EP 1 433 576 B1, or EP 1 854 590 B1.

Not only with regard to collaborative and cognitive robots, but also in general, it is desired for robot arms to be narrow and lightweight, to require little installation space in relation to their working space, and to have a structure that is as straight-lined as possible.

The invention is therefore based on the object of providing an arm portion which makes it possible to design a robot arm in such a way that it requires as little installation space as possible in relation to its working space.

This object is achieved according to the invention by an arm portion for a robot arm having the features of claim 1.

The invention is also based on the object of providing a part of a robot arm which requires as little installation space as possible in relation to its working space.

This object is achieved according to the invention by an arm part for a robot arm having the features of claim 8.

The invention is further based on the object of providing a robot arm which requires as little installation space as possible in relation to its working space and, moreover, can be manufactured in a simple and cost-effective manner.

This object is achieved according to the invention by a robot arm with the features of claim 7. The object is also achieved by a robot arm according to claim 10, 11, 15, 21 or 22.

Advantageous configurations and refinements of the invention are specified in the dependent claims.

An arm portion according to the invention for a robot arm has a portion longitudinal axis and at least one gear motor for actuating the at least one arm portion. The gear motor has a motor, a transmission and a gear motor housing, wherein a supporting structure of the arm portion is formed at least in portions exclusively by the gear motor housing along the portion longitudinal axis in the region of the gear motor housing. In the region of the gear motor housing an additional supporting element can therefore be omitted entirely. The arm portion according to the invention can therefore have a smaller installation space compared to the prior art.

The arm portion preferably extends longer in one of the three spatial directions than in the others. The portion longitudinal axis is preferably aligned along this spatial direction. The portion longitudinal axis is preferably designed as a straight line. The arm portion is particularly preferably designed to be substantially cylindrical, at least in portions. The term actuating here and below preferably includes both driving and braking. The gear motor can therefore also comprise a brake unit. In addition, the gear motor can have an encoder unit, in particular for determining the position of the gear motor. The at least one arm portion can be actuated relative to another arm portion or the environment. The arm portion is preferably understood to mean the portion of a robot arm that is movable relative to another portion of the robot arm. The arm portion is usually mounted at two connection points, in particular relative to another arm portion or relative to the environment. The supporting structure of the arm portion preferably connects the two connection points to one another with the task of transmitting forces and torques between the connection points.

In the region of the gear motor housing along the portion longitudinal axis, the supporting structure of the arm portion is formed, at least in portions, exclusively by the gear motor housing. As a result, the function of “transmitting forces and torques between the connection points of the arm portion” can be integrated into the gear motor housing in this region. At least in the region of the gear motor housing, the arm portion can therefore be designed free of an additional supporting element.

The arm portion is preferably designed to be straight. In this case, the portion longitudinal axis can connect the connection points of the arm portion in a straight line. The arm portion can therefore be free of curvatures. This allows a space-saving design of the robot arm to be achieved. In addition, the manufacture of the arm portion can be simplified. In particular, this makes it easier to implement a modular design of the robot arm.

Preferably, an output shaft of the gear motor is arranged parallel to the portion longitudinal axis. With such an arrangement, a small installation space can be achieved. In particular, this can avoid the robot arm being wide in the region of the connection points and taking up a lot of space. In addition, it is possible to deviate from the angular and often edgy design of conventional arm portions, which in particular can reduce the risk of injury. The term “parallel” preferably includes a coincident or adjoining arrangement of the output shaft and the portion longitudinal axis. The gear motor housing can be designed to be cylindrical, wherein the output shaft can protrude from the gear motor housing at one front face.

In a refinement of the invention, the gear motor has a motor shaft which is designed as a hollow shaft. The motor shaft can therefore be used in particular for the cable feedthrough. This allows the arm portion to be constructed more compactly and further optimized in terms of installation space. Cables routed in the motor shaft can be, for example, electrical cables or media-carrying cables such as compressed air lines.

The transmission is preferably designed as a three-shaft transmission. Transmissions of this type can achieve large gear ratios while simultaneously requiring little installation space. The three-shaft transmission can be designed as a planetary transmission, cycloidal transmission unit or shaft transmission, for example.

A further gear motor and/or an extension piece for extending the arm portion and/or further functional modules can be arranged on the arm portion along the portion longitudinal axis. The further gear motor, the extension piece and the further functional modules preferably form a component of the arm portion. The further gear motor can be arranged in such a way that each of the gear motors can actuate the arm portion with regard to one of the connection points. By arranging the extension piece, the length of the arm portion along the portion longitudinal axis can be adapted to the respective boundary conditions. The extension piece is preferably available in different lengths. One of the further functional modules can, for example, be formed by a status display module which, for example, displays information about the operating state of the gear motor or the arm portion. In addition, one of the further functional modules can be designed as an input module. Preferably, the further gear motor, the extension piece and the further functional modules each form the sole supporting structure of the arm portion, at least in portions along the portion longitudinal axis.

A robot arm according to the invention comprises at least one arm portion as described above.

An arm part for a robot arm comprises a second arm portion with a second portion longitudinal axis, a second gear motor, and a third gear motor. The arm part also comprises a third arm portion adjoining the second arm portion, which has a fourth gear motor. In this case, the third arm portion is actuatable by means of the third gear motor about the second portion longitudinal axis relative to the second arm portion. Such an arrangement enables the integration of a large number of functions, in particular drives, into the arm part. The arm part can therefore have a high density, in particular of drive components. The drive components can thus be accommodated in the robot arm in a particularly space-saving manner. The second gear motor, the third gear motor and the fourth gear motor are preferably arranged along the second portion longitudinal axis. Each of these gear motors can each have a motor shaft, which is particularly preferably arranged on the second portion longitudinal axis. The second gear motor, the third gear motor and the fourth gear motor can thus be arranged in a row along the second portion longitudinal axis. Preferably, the third motor is arranged so as to adjoining the second gear motor and/or adjoin the fourth gear motor.

The second arm portion and/or the third arm portion may each be formed by the previously described arm portion.

A robot arm according to the invention can comprise a first arm portion having a first portion longitudinal axis and a first gear motor. In addition, the robot arm has a second arm portion having a second portion longitudinal axis and a second gear motor and adjoining the first arm portion. Alternatively, the robot arm has an arm part, as described above, which adjoins the first arm portion with the second arm portion. In both alternatives, the second arm portion is mounted relative to the first arm portion so as to be rotatable about an articulation axis arranged at an angle to the first portion longitudinal axis and the second portion longitudinal axis. In this case, the first arm portion and the second arm portion are each formed by the arm portion described above. The articulation axis preferably has a right-angular offset from the first portion longitudinal axis and/or with respect to the second portion longitudinal axis. The articulation axis is preferably arranged outside the first and second arm portions.

The robot arm can be designed in such a way that a torque acting about the articulation axis is transmittable between the second arm portion and the first arm portion by means of an angular gear which has a driving element arranged on the second arm portion and an output element arranged on the first portion. As a result, the torque can be transmitted from the second arm portion to the first arm portion, and vice versa, with little installation space required. In particular, this makes it possible to implement a robot arm which is free from a space-consuming and angular structure in the region of the articulation axis. Preferably, the driving element of the angular gear is connected in a rotationally fixed manner to a second output shaft of the second gear motor or is formed by the latter. In a particularly preferred embodiment, the second output shaft can be arranged with an angular, in particular right-angular, offset from the articulation axis.

In one embodiment of the invention, the driving element is arranged on the second gear motor and the output element is arranged on the first arm portion. This allows the second arm portion to be actuated relative to the first arm portion from the second arm portion. Since the first arm portion preferably only needs to have the output element in order to be able to implement torque transmission, the robot arm can be built to take up little space, particularly with regard to the first arm portion.

The angular gear can have a downshift starting from the driving element. In this way, the high torque required on the articulation axis can be generated directly on the articulation axis and the drive train arranged in front of it, as viewed from the second gear motor, can be dimensioned accordingly to be lightweight and space-saving.

In a preferred embodiment of the invention, the angular gear is designed as a bevel gear and the driving element is formed by a drive bevel gear wheel and the output element is formed by an output bevel gear wheel. The bevel gear represents a lightweight and cost-effective implementation of the angular gear.

In a robot arm according to the invention, the second arm portion can be mounted about the articulation axis relative to a first arm portion in such a way that the first arm portion has a fork-shaped first connection element with a first fork extension and a second fork extension, with a second connection element of the second arm portion being arranged between the first fork extension and the second fork extension. This makes it possible to achieve rigid mounting while maintaining low weight. The first fork extension and the second fork extension preferably form the two legs of a U.

The second connection element is preferably fork-shaped with a third fork extension and a fourth fork extension, wherein the third fork extension can be mounted against the first fork extension and the fourth fork extension can be mounted against the second fork extension. This allows the mounting to be further improved in terms of weight and rigidity.

The first connection element, in an imaginary first plane spanned by the articulation axis and the first portion longitudinal axis, and/or the second connection element, in an imaginary second plane spanned by the articulation axis and the second portion longitudinal axis, can each have a U-shaped cross-section. The first connection element and/or the second connection element therefore preferably have a bowl-shaped cross-section. This can increase the rigidity of the connection elements. The U-shape can be configured such that it has a constant radius. This means that the cross-section of the respective connection element can be designed to be spherical.

In a preferred embodiment of the invention, the output element of the angular gear is connected in a rotationally fixed manner to the first fork extension and/or the second fork extension of the first connection element. In this way, the torque transmission about the articulation axis can be implemented in a structurally simple and space-saving manner.

The second connection element particularly preferably has a housing for the angular gear. The housing can be integrated into the second connection element. This allows the robot arm to be designed to be particularly safe, in particular with regard to collaboration with humans.

In one embodiment of the invention, the second connection element can have an angle sensor for determining the position of the output element. In particular, together with an encoder unit arranged in the second gear motor, this allows a reliable, redundant position measurement to be carried out.

In a further development of the invention, the robot arm has a fourth arm portion, wherein the third arm portion is mounted relative to the fourth arm portion so as to be rotatable about a second articulation axis arranged with an angular offset from the second portion longitudinal axis, and wherein the arrangement of the third arm portion relative to the fourth arm portion is designed in accordance with the arrangement of the second arm portion relative to the first arm portion. This arrangement can comprise the mounting and all elements required for the operative connection between the adjoining arm portions.

Accordingly, the robot arm can be designed in such a way that a torque acting about the second articulation axis is transmittable between the third arm portion and the fourth arm portion by means of a second angular gear, which has a driving element arranged on the third arm portion and an output element arranged on the fourth arm portion. Preferably, the driving element of the second angular gear is connected in a rotationally fixed manner to a fourth output shaft of the fourth gear motor, or is formed by the latter. In a particularly preferred embodiment, the fourth output shaft can be arranged with an angular, in particular right-angular, offset from the second articulation axis.

In one embodiment of the invention, the driving element of the second angular gear is arranged on the fourth gear motor and the output element of the second angular gear is arranged on the fourth arm portion. The fourth arm portion can thus be actuated from the third arm portion relative to the third arm portion. The second angular gear can have a downshift starting from the driving element.

In a preferred embodiment of the invention, the second angular gear is designed as a bevel gear and the driving element is formed by a drive bevel gear wheel and the output element is formed by an output bevel gear wheel.

In a robot arm according to the invention, the third arm portion can be mounted relative to the fourth arm portion about the second articulation axis in such a way that the fourth arm portion has a fork-shaped fourth connection element, preferably corresponding to the first connection element, with a first fork extension and a second fork extension. Preferably, a third connection element of the third arm portion, preferably corresponding to the second connection element, is arranged between the first fork extension and the second fork extension of the fourth connection element. Preferably, the first fork extension and the second fork extension of the fourth connection element form the two legs of a U.

The third connection element is preferably fork-shaped with a third fork extension and a fourth fork extension, wherein the third fork extension can be mounted against the first fork extension of the fourth connection element and the fourth fork extension can be mounted against the second fork extension of the fourth connection element.

The fourth connection element can have a U-shaped cross-section in an imaginary fourth plane spanned by the second articulation axis and a fourth portion longitudinal axis, and/or the third connection element can have a U-shaped cross-section in an imaginary third plane spanned by the second articulation axis and the second portion longitudinal axis. The third connection element and/or the fourth connection element therefore preferably have a bowl-shaped cross-section. The U-shape can be configured such that it has a constant radius. The cross-section of the respective connection element can therefore be designed to be spherical.

In a preferred embodiment of the invention, the output element of the second angular gear is connected in a rotationally fixed manner to the first fork extension and/or the second fork extension of the fourth connection element. The third connection element particularly preferably has a housing for the second angular gear. The housing can be integrated into the third connection element.

In one embodiment of the invention, the third connection element can have an angle sensor for determining the position of the output element. In particular, together with an encoder unit arranged in the third gear motor, this allows a reliable, redundant position measurement to be carried out.

The robot arm can be designed in such a way that the first arm portion adjoins a base, wherein the first arm portion is actuatable relative to the base by means of the first gear motor, wherein the second arm portion is actuatable relative to the first arm portion by means of the second gear motor, and wherein the second arm portion has a third gear motor, by means of which a third arm portion adjoining the second arm portion is actuatable relative to the second arm portion. The base preferably forms the interface between the robot arm and the environment. Because the first arm portion preferably only has the first gear motor, it can be designed to be very short along the first portion longitudinal axis. This means that points in the immediate vicinity of the base can be reached with the end of the robot arm remote from the base with relatively small movements and little effort. Overall, the working space of the robot arm can thus be expanded further in comparison to its installation space. The term working space describes here the totality of all points that can be reached from the end of the robot arm remote from the base.

In a further development of the invention, the first arm portion is mounted relative to the base so as to be rotatable about the first portion longitudinal axis, and the third arm portion is mounted relative to the second arm portion so as to rotate about the second portion longitudinal axis. Such an arrangement makes it possible to implement a large working space while simultaneously keeping the installation space of the robot arm small.

In a refinement of the invention, a flexible energy-dissipating cover is arranged on at least one of the arm portions of the robot arm, which at least partially covers the robot arm. If the robot arm collides with people or objects in the vicinity in the region of the cover, the energy acting at the contact point can be dissipated quickly and effectively by the robot arm and the energy effect on the colliding person or object and their associated deformation can be minimized. This can reduce the risk of injury, particularly when using the robot arm with a collaborative robot.

This effect can be enhanced by the cover being resiliently mounted on the robot arm. In particular, the cover can be resiliently mounted on the robot arm by means of at least one fold.

The cover can have at least one sensor for detecting a collision of the robot arm. The sensor can be designed in particular as a touch sensor and/or proximity sensor and/or deformation sensor. The touch sensor can detect a contact and thus a collision with a person or an object. The proximity sensor can detect an approach to a person or an object before a collision occurs. The deformation sensor can detect a deformation of the cover as a result of a collision. As a result of one or more of the detections described above, measures can be taken to avoid and/or mitigate the collision or its consequences. In particular, an immediate interruption of the movement of the robot arm can be initiated. This can further increase safety, especially when the robot arm is used collaboratively.

Exemplary embodiments of the invention are explained using the following figures. In the figures:

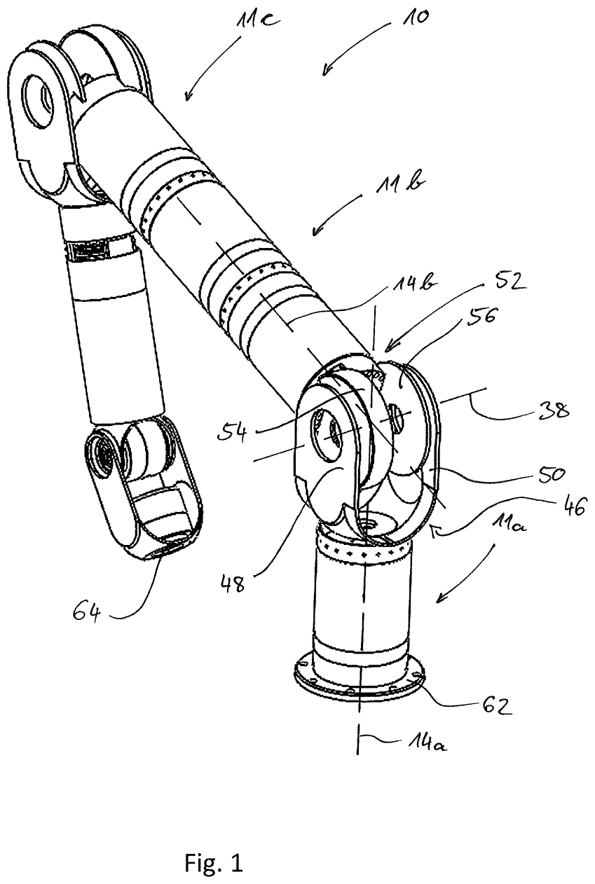

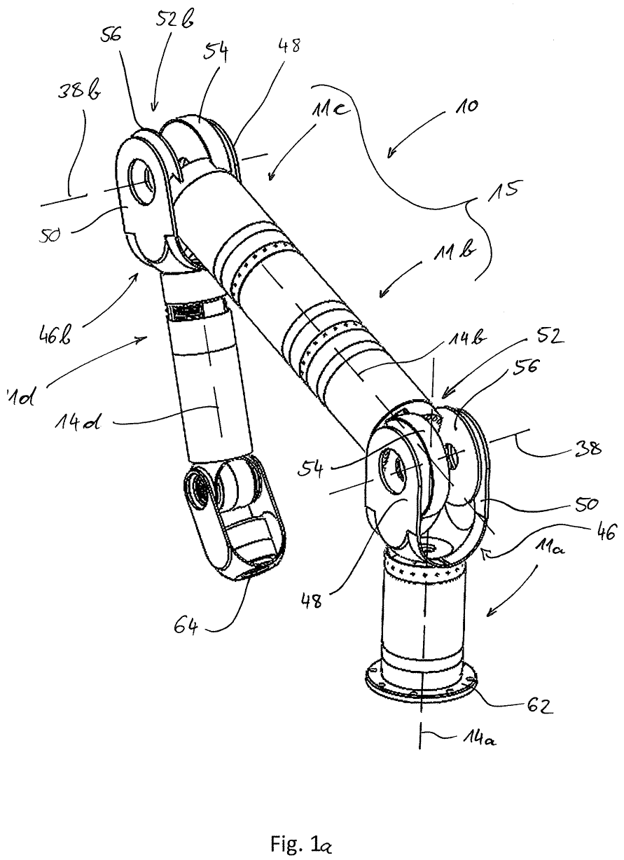

FIG. 1 shows a perspective view of a first exemplary embodiment of a robot arm with multiple arm portions in a first pose,

FIG. 1a shows the representation shown in FIG. 1 with additional reference numerals,

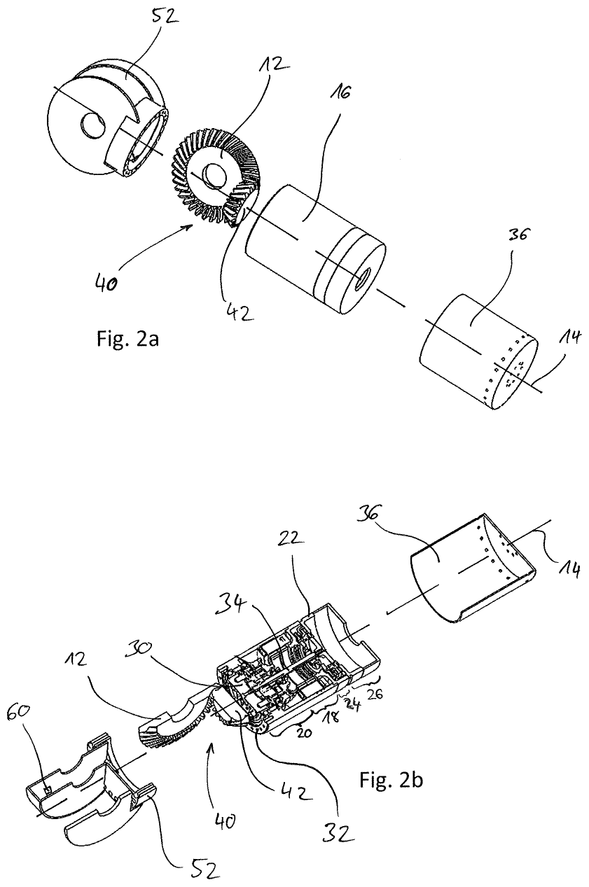

FIG. 2a shows an exploded view of a part of an arm portion and an output bevel gear wheel,

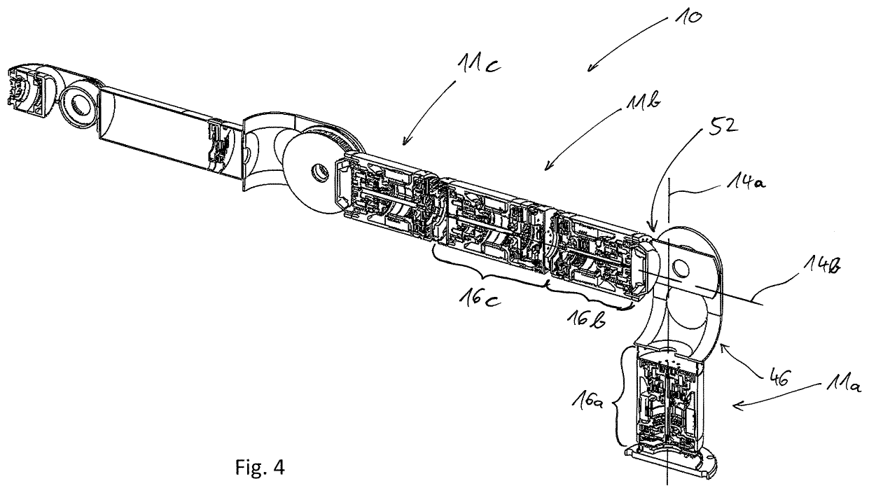

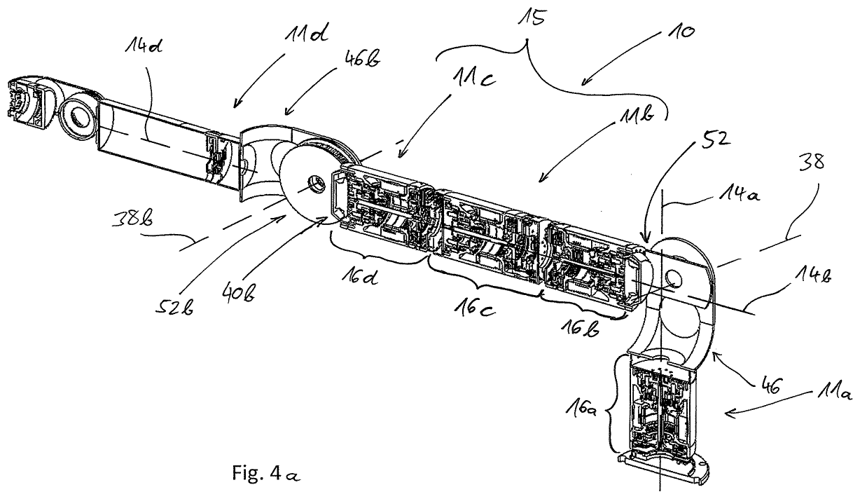

FIG. 2b shows a perspective sectional view of the arrangement shown in FIG. 4a,

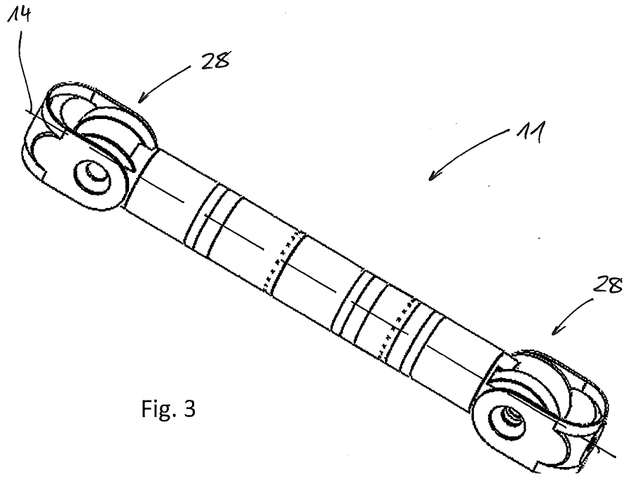

FIG. 3 shows a perspective view of the second arm portion of the exemplary embodiment shown in FIG. 1 and fork-shaped connecting elements of the adjoining arm portions,

FIG. 4 shows a perspective sectional view of the robot arm shown in FIG. 1 in a second pose,

FIG. 4a shows the representation shown in FIG. 4 with additional reference numerals,

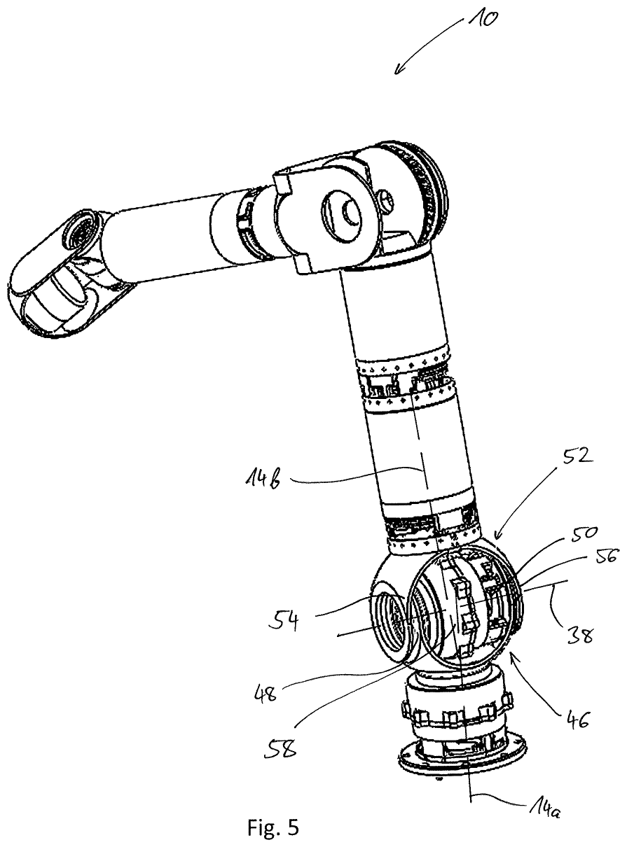

FIG. 5 shows a perspective view of a second exemplary embodiment of a robot arm,

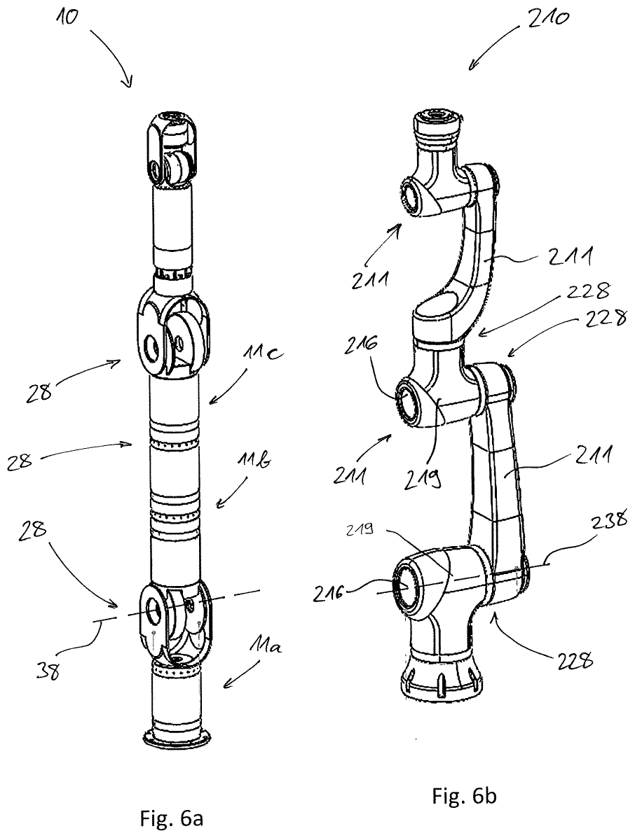

FIG. 6a shows the robot arm shown in FIG. 1 in a third pose,

FIG. 6b shows a prior art robot arm in the same pose as the robot arm shown in FIG. 6a.

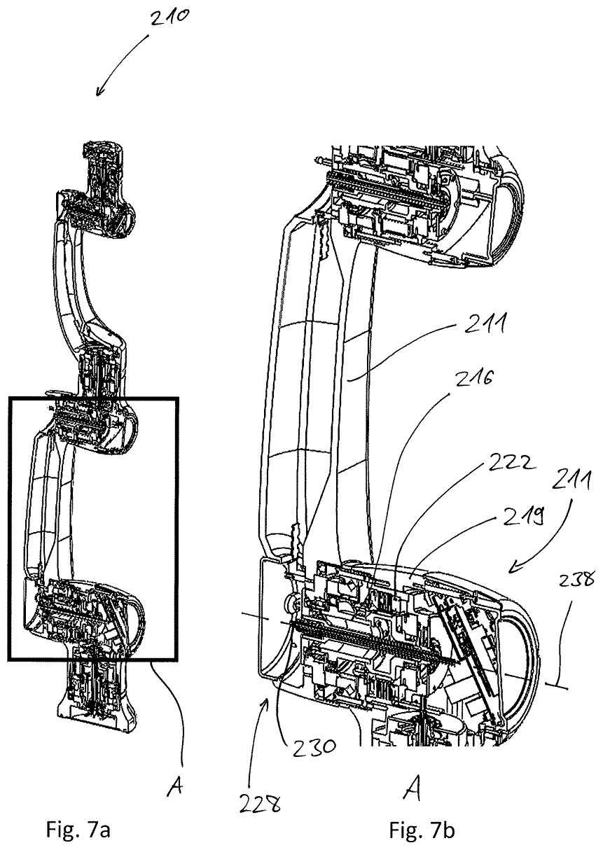

FIG. 7a shows a cross-section of the robot arm shown in FIG. 6b with a section marked A,

FIG. 7b shows the section marked A in FIG. 7a of the cross portion shown in FIG. 7a,

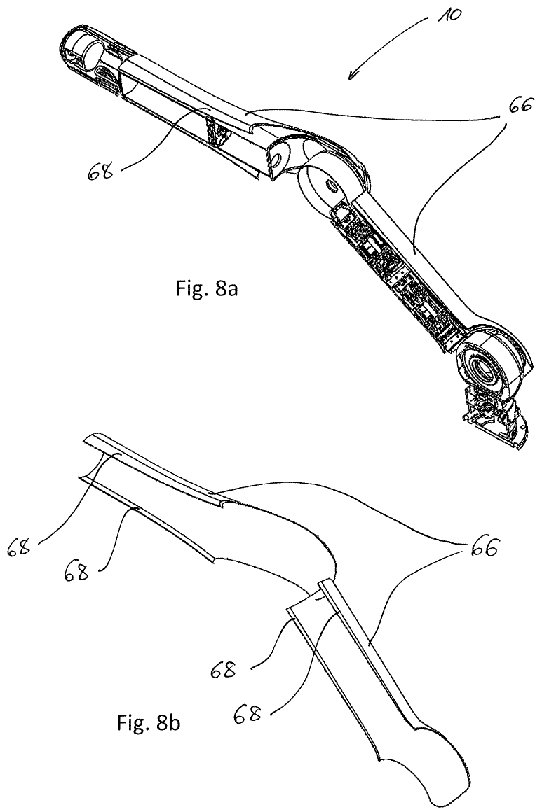

FIG. 8a shows a perspective view of a third exemplary embodiment of a robot arm with a cover,

FIG. 8b shows a perspective view of the cover shown in FIG. 8a.

FIGS. 1 to 8b show various exemplary embodiments. The same reference numerals are used for identical and functionally identical parts.

FIG. 1 shows a first exemplary embodiment of a robot arm 10 with several arm portions 11. A part of one of the arm portions 11 is shown together with an output bevel gear wheel 12 in FIG. 2a. Arm portion 11 has a portion longitudinal axis 14 and a gear motor 16 for actuating arm portion 11. As illustrated in FIG. 2b, gear motor 16 has a motor 18, a transmission 20 and a gear motor housing 22, wherein along portion longitudinal axis 14 in the region of gear motor housing 22 a supporting structure of arm portion 11 is formed at least in portions exclusively by gear motor housing 22.

As can be seen in particular from FIG. 3, arm portion 11 can extend longer in one of the three spatial directions than in the others. Portion longitudinal axis 14 is preferably aligned along this spatial direction and is designed as a straight line. Arm portion 11 is particularly preferably designed to be substantially cylindrical, at least in portions.

Gear motor 16 can comprise a brake unit 24 (FIG. 2b). In addition, gear motor 16 can have an encoder unit 26, in particular for determining the position of gear motor 16, for which only an empty section of gear motor housing 22 is shown in FIG. 2b.

Arm portion 11 can be actuated relative to another arm portion 11 or the environment. Arm portion 11 is usually mounted at two connection points 28, in particular relative to another arm portion 11 or relative to the environment. The supporting structure of arm portion 11 preferably connects two connection points 28 to one another with the task of transmitting forces and torques between connection points 28.

In the region of gear motor housing 22 along portion longitudinal axis 14, the supporting structure of arm portion 11 is formed, at least in portions, exclusively by gear motor housing 22. As a result, in this region, the function of “transferring forces and torques between connection points 28 of arm portion 11” can be integrated into gear motor housing 22. At least in the region of gear motor housing 22, arm portion 11 can thus be designed free of an additional support element.

Such an additional support element can be, for example, an additional robot housing 219, as shown in FIG. 6b. While FIG. 6a shows a robot arm 10, FIG. 6b shows a robot arm 210 of the prior art. Robot arm 210 has arm portions 211. In conventional robot arm 210, gear motors 216 used there are each arranged in a robot housing 219, which forms the supporting structure of respective arm portion 211. FIG. 7a shows a cross-section through conventional robot arm 210. In particular, section A, shown enlarged in FIG. 7b, shows that in conventional robot arm 210 gear motor 216 has a gear motor housing 222. Gear motor housing 222 is supported against robot housing 219, which completely surrounds gear motor housing 222. The supporting structure, which connects the two connection points to one another and transmits forces and torques between connection points 228 of the arm portion, is formed in the region of gear motor housing 222 by robot housing 219. In the region of gear motors 216, the supporting structure is thus formed by robot housing 219.

As illustrated in particular in FIG. 3, arm portion 11 is preferably designed to be straight. Portion longitudinal axis 14 can in this case connect connection points 28 of arm portion 11 in a straight line. Arm portion 11 can therefore be free of curvatures. As the comparison of robot arms 10, 210 illustrated in FIG. 6a and FIG. 6b shows, robot arm 10 can therefore be designed to take up significantly less space, whereas robot arm 210 of the prior art is significantly wider due, among other things, to the curved arm portions 211.

The cross portion in FIG. 2b shows that an output shaft 30 of gear motor 16 is preferably arranged parallel to portion longitudinal axis 14. With such an arrangement it can be avoided in particular that robot arm 10 in the region of connection points 28 is wide and takes up a lot of space. For illustration, reference is made to FIG. 6b. Robot arm 210 shown there has a particularly space-consuming structure compared to robot arm 10, particularly in the region of connection points 228. Gear motor housing 22 can be designed to be cylindrical, wherein output shaft 30 can protrude from gear motor housing 22 at an end face 32.

Gear motor 16 can have a motor shaft 34 which is designed as a hollow shaft. Motor shaft 34 can therefore serve in particular for cable feedthrough. Lines routed in motor shaft 34 can be, for example, electrical lines or media-carrying lines such as compressed air lines. Transmission 20 is preferably designed as a three-shaft transmission, particularly preferably as a planetary transmission.

An extension piece 36 for extending arm portion 11 can be arranged on arm portion 11 along the portion longitudinal axis 14. Extension piece 36 is preferably available in different lengths. Extension piece 36 preferably forms a component of arm portion 11.

Extension piece 36 can form the sole supporting structure of arm portion 11, at least in portions, along portion longitudinal axis 14, in particular adjoining gear motor housing 22.

Robot arm 10 illustrated in FIGS. 1, 4 and 6a can have a first arm portion 11a having a first portion longitudinal axis 14a and a first gear motor 16a. In addition, robot arm 10 can have a second arm portion 11b having a second portion longitudinal axis 14b and a second gear motor 16b, and adjoins the first arm portion 11a. In addition, second arm portion 11b can have a third gear motor 16c. Second arm portion 11b can be part of an arm part 15 which, in addition to the second arm portion 11b, comprises a third arm portion 11c adjoining the second arm portion 11b and has a fourth gear motor 16d. Third arm portion 11c is actuatable by means of third gear motor 16c about second portion longitudinal axis 14b relative to second arm portion 11b (see in particular FIG. 4b).

Preferably, second gear motor 16b, third gear motor 16c and fourth gear motor 16d are arranged along second portion longitudinal axis 14b. Each of motor shafts 34 of gear motors 16b, 16c, 16d is particularly preferably arranged on second portion longitudinal axis 14b. Second gear motor 16b, third gear motor 16c and fourth gear motor 16d can thus be arranged in a row along second portion longitudinal axis 14b. Preferably, third gear motor 16c is arranged to adjoin second gear motor 16b and to adjoin the fourth gear motor 16d.

Second arm portion 11b can be mounted relative to first arm portion 11a so as to be rotatable about an articulation axis 38 arranged with a right-angular offset from first portion longitudinal axis 14a and second portion longitudinal axis 14b. First arm portion 11a, second arm portion 11b and third arm portion 11c are each formed by previously described arm portion 11. Articulation axis 38 is preferably arranged outside first arm portion 11a and second arm portion 11b.

Robot arm 10 can be designed in such a way that a torque acting about articulation axis 38 is transmittable between second arm portion 11b and first arm portion 11a by means of an angular gear designed as a bevel gear 40, which has a drive bevel gear wheel 42 arranged on second arm portion 11b and the output bevel gear wheel 12 arranged on first portion 11a (see in particular FIG. 4). Bevel gear 40 is shown particularly clearly in FIGS. 2a and 2b. In particular, robot arm 10 can thus be implemented free of a space-consuming and angular structures in the region of articulation axis 38. Drive bevel gear wheel 42 preferably forms a second output shaft 30b of second gear motor 16b. Second output shaft 30b can be arranged with an angular, in particular right-angular, offset from articulation axis 38.

The effect of such an arrangement, in particular on the required installation space, is again apparent when comparing robot arm 10 illustrated in FIG. 6a with robot arm 210 of the prior art illustrated in FIG. 6b. In the region of an articulated axis 238, robot arm 210 is significantly wider. The cross-section in FIGS. 7a and 7b illustrates the design background: An angular gear such as bevel gear 40 is not present. Gear motor 216, on the other hand, is arranged on articulation axis 238 in such a way that an output shaft 230 of gear motor 216 is arranged parallel to articulation axis 238.

Preferably, drive bevel gear wheel 42 is arranged on second gear motor 16b and output bevel gear wheel 12 is arranged on first arm portion 11a. Thus, second arm portion 11b can be actuated relative to first arm portion 11a from second arm portion 11b.

As is particularly clear from the diameter ratio of drive bevel gear wheel 42 and output bevel gear wheel 12, bevel gear 40 can have a downshift starting from drive bevel gear wheel 12. In this way, the high torque required on articulation axis 38 can be generated directly on articulation axis 38, and the drive train arranged in front of it, as viewed from the second gear motor 16b, in particular the transmission 20, can be dimensioned accordingly to be lightweight and space-saving.

As illustrated in FIG. 1, second arm portion 11b can be mounted relative to a first arm portion 11a about articulation axis 38 in such a way that first arm portion 11a has a fork-shaped first connection element 46 with a first fork extension 48 and a second fork extension 50, with a second connection element 52 of second arm portion 11b being arranged between first fork extension 48 and second fork extension 50. Preferably, first fork extension 48 and second fork extension 50 form the two legs of a U. Output bevel gear wheel 12 is preferably connected in a rotationally fixed manner to first fork extension 48.

Second connection element 52 is preferably fork-shaped with a third fork extension 54 and a fourth fork extension 56, wherein third fork extension 54 can be mounted against first fork extension 48 and fourth fork extension 56 can be mounted against second fork extension 50.

Second connection element 52 particularly preferably has a housing for bevel gear 40. As can be seen from FIGS. 2a and 2b, a housing for bevel gear 40 can be integrated into second connection element 52. Second connection element 52 can have an angle sensor 60 for determining the position of output bevel gear wheel 12.

First connection element 46 can have a U-shaped cross-section in an imaginary first plane spanned by articulation axis 38 and first portion longitudinal axis 14a. The first connection element therefore preferably has a bowl-shaped cross-section.

As illustrated in FIG. 5, the robot arm can be designed such that the torque driving or braking about articulation axis 38 is provided by a drive unit arranged on articulation axis 38. For this purpose, drive unit 58 can be arranged between first fork extension 48 and second fork extension 50, which in turn can be arranged between third fork extension 54 and fourth fork extension 56. Furthermore, the arrangement in FIG. 5 shows that in addition to first connection element 46, second connection element 52 can also have a U-shaped cross-section, preferably in an imaginary second plane spanned by articulation axis 38 and second portion longitudinal axis 14b. The U-shape can be configured such that it has a constant radius. The cross-section of first connection element 46 and second connection element 52 can therefore each be spherical.

As can also be seen in particular from FIGS. 1 and 4, with the corresponding reference numerals in FIGS. 1a and 4a, the robot arm can have a fourth arm portion 11d, wherein third arm portion 11c is mounted relative to fourth arm portion 11d so as to be rotatable about a second articulation axis 38 which is arranged with an angular, in particular a right-angular, offset from the second portion longitudinal axis 14b. The arrangement of third arm portion 11c relative to fourth arm portion 11d is preferably designed to correspond to the arrangement of second arm portion 11b relative to first arm portion 11a. This arrangement can comprise the mounting and all elements required for the operative connection between adjoining arm portions.

Accordingly, robot arm 10 can be designed in such a way that a torque acting about second articulation axis 38b is transmittable between third arm portion 11c and fourth arm portion 11d by means of a second bevel gear 40b. Second bevel gear 40b preferably corresponds to the bevel gear 40 and can therefore also have the drive bevel gear wheel 42 and output bevel gear wheel 12. Drive bevel gear wheel 42 of second bevel gear 40b is preferably arranged on third arm portion 11c, output bevel gear wheel 12 of second bevel gear 40b is arranged on fourth arm portion 11d.

According to the illustration in FIG. 2b, drive bevel gear wheel 42 of second bevel gear 40b can be arranged on fourth gear motor 16c, and output bevel gear wheel 12 of second bevel gear 40b can be arranged on fourth arm portion 11d. As shown in FIG. 4, fourth arm portion 11d can thus be actuated relative to third arm portion 11c from third arm portion 11c.

As is shown in particular in FIGS. 1 and 4, in robot arm 10 third arm portion 11c can be mounted relative to fourth arm portion 11d about second articulation axis 38b in such a way that fourth arm portion 11d has a fork-shaped fourth connection element 46b. The corresponding reference numerals are provided in FIGS. 1a and 4a. Fourth connection element 46b preferably corresponds to first connection element 46. The fourth connection element can therefore also have first fork extension 48 and second fork extension 50, which form the two legs of a U. A third connection element 52b of third arm portion 11c can be arranged between first fork extension 48 and second fork extension 50 of fourth connection element 46b. Preferably, the first fork extension and the second fork extension of the fourth connection element form the two legs of a U.

Third connection element 52b is preferably designed to correspond to second connection element 52. In particular, it can be designed to be fork-shaped. Third connection element 52b can therefore also have third fork extension 54 and fourth fork extension 56. In this case, third fork extension 54 can be mounted against first fork extension 48 of fourth connection element 46b, and fourth fork extension 56 can be mounted against second fork extension 50 of fourth connection element 46b.

Fourth connection element 46b can have a U-shaped cross-section in an imaginary fourth plane spanned by second articulation axis 38b and a fourth portion longitudinal axis 14d, and third connection element 52b can have a U-shaped cross-section in an imaginary third plane spanned by second articulation axis 38b and second portion longitudinal axis 14b. Third connection element 52b and fourth connection element 46b therefore preferably have a bowl-shaped cross-section.

Robot arm 10 illustrated in FIGS. 1, 4 and 6 can be designed in such a way that first arm portion 11a adjoins a base 62, wherein first arm portion 11a is actuatable relative to base 62 by means of first gear motor 16a. Second arm portion 11b can be actuatable relative to first arm portion 11a by means of second gear motor 16b. In addition, second arm portion 11b can have third gear motor 16c, by means of which third arm portion 11c adjoining second arm portion 11b is actuatable relative to second arm portion 11b. Base 62 preferably forms the interface between robot arm 10 and the environment. Because first arm portion 11a preferably only has first gear motor 16a, it can be designed to be very short along first portion longitudinal axis 14a. As a result, points in the immediate vicinity of base 62 can be reached with an end 64 of robot arm 10 remote from base 62 with relatively small movements and little effort.

First arm portion 11a is preferably mounted relative to base 62 so as to be rotatable about the first portion longitudinal axis 14a. Third arm portion 11c is preferably mounted relative to the second arm portion 11b so as to be rotatable about second portion longitudinal axis 14b.

As shown in FIG. 8a, a flexible energy-dissipating cover 66 can be arranged on at least one of arm portions 11, 11a, 11b of robot arm 10, which at least partially covers robot arm 10. This can reduce the risk of injury, especially when using robot arm 10 with a collaborative robot.

This effect can be enhanced by cover 66 being resiliently mounted on robot arm 10. In particular, cover 66 can be resiliently mounted on the robot arm 10 by means of at least one fold 68. Cover 66 on its own is shown in FIG. 8b.

Cover 66 can have at least one sensor (not shown in FIGS. 8a and 8b) for detecting a collision of the robot arm. This can further increase safety, particularly when robot arm 10 is used collaboratively.

### LIST OF REFERENCE NUMERALS

10 robot arm
11 arm portion
11a first arm portion
11b second arm portion
11c third arm portion
11d fourth arm portion
12 output bevel gear wheel
14 portion longitudinal axis
14a first portion longitudinal axis
14b second portion longitudinal axis
14d fourth portion longitudinal axis
15 arm part
16 gear motor
16a first gear motor
16b second gear motor
16c third gear motor
16d fourth gear motor
18 motor
20 transmission
22 gear motor housing
24 brake unit
26 encoder unit
28 connection point
30 output shaft
30b second output shaft
32 end face
34 motor shaft
36 extension piece
38 articulation axis
38b second articulation axis
40 bevel gear
40b second bevel gear
42 drive bevel gear wheel
46 first connection element
46 fourth connection element
48 first fork extension
50 second fork extension
52 second connection element
52b third connection element
54 third fork extension
56 fourth fork extension
58 drive unit
60 angle sensor
62 base
64 remote end
66 cover
68 fold
210 robot arm (prior art)
211 arm portion (prior art)
216 gear motor (prior art)
219 robot housing
222 gear motor housing
228 connection point
230 output shaft
238 articulation axis

1. An arm portion (11) for a robot arm (10) with a portion longitudinal axis (14) and with at least one gear motor (16) for actuating the at least one arm portion (11), the gear motor (16) having a motor (18), a transmission (20) and a gear motor housing (22),
characterized in that
a supporting structure of the arm portion is formed at least in portions exclusively by the gear motor housing (22) along the portion longitudinal axis (14) in the region of the gear motor housing (22).

2. The arm portion (11) according to claim 1, characterized in that the arm portion (11) is straight.

3. The arm portion (11) according to claim 1,
characterized in that
an output shaft (30) of the gear motor (16) is arranged parallel to the portion longitudinal axis (14).

4. The arm portion (11) according to claim 1,
characterized in that
the gear motor (16) has a motor shaft (34) which is designed as a hollow shaft.

5. The arm portion (11) according to claim 1,
characterized in that
the transmission (20) is designed as a three-shaft transmission.

6. The arm portion (11) according to claim 1,
characterized in that
a further gear motor (16) and/or an extension piece (36) for extending the arm portion (11) and/or further functional modules can be arranged on the arm portion (11) along the portion longitudinal axis (14).

7. A robot arm (10) with at least one arm portion (11) according to claim 1.

8. An arm part (15) for a robot arm (10) with
a second arm portion (11b) comprising
a second portion longitudinal axis (14b),
a second gear motor (16b), and
a third gear motor (16c),
a third arm portion (11c) adjoining the second arm portion (11b), comprising a fourth gear motor (16d),
wherein the third arm portion (11c) is actuatable by means of the third gear motor (16c) about the second portion longitudinal axis (14b) relative to the second arm portion.

9. The arm part (15) according to claim 8,
characterized in that
the second arm portion (11b) and/or the third arm portion (11c) are each formed by an arm portion (11).

10. A robot arm (10) with a first arm portion (11a) having a first portion longitudinal axis (14a) and a first gear motor (16a), and
a second arm portion (11b), which has a second portion longitudinal axis (14b) and a second gear motor (16b) and adjoins the first arm portion (11a),
or
an arm part (15) according to claim 8 with the second arm portion (11b) adjoining the first arm portion (11a),
wherein the second arm portion (11b) is mounted relative to the first arm portion (11a) so as to be rotatable about an articulation axis (38) arranged with an angular offset from the first portion longitudinal axis (14a) and the second portion longitudinal axis (14b),
characterized in that
the first arm portion (11a) and the second arm portion (11b) are each formed by an arm portion (11).

11. The robot arm (10) according to claim 10,
characterized in that
a torque acting about the articulation axis (38) is transmittable between the second arm portion (11b) and the first arm portion (11a) by means of an angular gear which has a driving element arranged on the second arm portion (11b) and an output element arranged on the first portion (11a).

12. The robot arm (10) according to claim 11,
characterized in that
the driving element is arranged on the second gear motor (16b) and the output element is arranged on the first arm portion (11a).

13. The robot arm (10) according to claim 11, characterized in that
the angular gear has a downshift starting from the driving element.

14. The robot arm (10) according to claim 11, characterized in that
the angular gear is designed as a bevel gear (40) and the driving element is formed by a drive bevel gear wheel (42) and the output element is formed by an output bevel gear wheel (12).

15. The robot arm (10) according to claim 10, characterized in that the second arm portion (11b) is mounted relative to a first arm portion (11a) about the articulation axis (38) such that the first arm portion (11a) has a fork-shaped first connection element (46) with a first fork extension (48) and a second fork extension (50), wherein a second connection element (52) of the second arm portion (11b) is arranged between the first fork extension (48) and the second fork extension (50).

16. The robot arm (10) according to claim 15,
characterized in that
the second connection element (52) is fork-shaped with a third fork extension (54) and a fourth fork extension (56), the third fork extension (54) being mounted against the first fork extension (48) and the fourth fork extension (56) being mounted against the second fork extension (50).

17. The robot arm (10) according to claim 15, characterized in that the first connection element (46), in an imaginary first plane spanned by the articulation axis (38) and the first portion longitudinal axis (14a), and/or the second connection element (52), in an imaginary second plane spanned by the articulation axis (38) and the second portion longitudinal axis (14b), each have a U-shaped cross-section.

18. The robot arm (10) according to claim 11,
characterized in that
the output element of the angular gear is connected in a rotationally fixed manner to the first fork extension (48) and/or the second fork extension (50) of the first connection element (46).

19. The robot arm (10) according to claim 11,
characterized in that
the second connection element (52) has a housing for the angular gear.

20. The robot arm (10) according to claim 11,
characterized in that
the second connection element (52) has an angle sensor (60) for determining the position of the output element.

21. The robot arm (10)
according to claim 10 with an arm part (15) adjoining the first arm portion (11a) with the second arm portion (11b),
or with an arm part (15) adjoining the first arm portion (11a) with the second arm portion (11b),
characterized in that
the robot arm (10) has a fourth arm portion (11d), the third arm portion (11c) being mounted relative to the fourth arm portion (11d) so as to be rotatable about a second articulation axis (38b) arranged with an angular offset from the second portion longitudinal axis (14b), and wherein the arrangement of the third arm portion (11c) relative to the fourth arm portion (11d) is designed in accordance with the arrangement of the second arm portion (11b) relative to the first arm portion (11a).

22. The robot arm (10) according to claim 10, characterized in that
the first arm portion (11a) adjoins a base (62), wherein the first arm portion (11a) is actuatable relative to the base (62) by means of the first gear motor (16a), wherein the second arm portion (11b) is actuatable relative to the first arm portion (11a) by means of the second gear motor (16b), and wherein the second arm portion (11b) has a third gear motor (16c), by means of which a third arm portion (11c) adjoining the second arm portion (11b) is actuatable relative to the second arm portion (11b).

23. The robot arm (10) according to claim 22, characterized in that the first arm portion (11a) is mounted relative to the base (62) so as to be rotatable about the first portion longitudinal axis (14a), and the third arm portion (11c) is mounted relative to the second arm portion (11b) so as to be rotatable about the second portion longitudinal axis (14b).

24. Robot arm (10) according to claim 1, characterized in that
a flexible energy-dissipating cover (66) is arranged on at least one of the arm portions (11, 11a, 11b), which at least partially covers the robot arm.

25. The robot arm (10) according to claim 24, characterized in that the cover (66) is resiliently mounted on the robot arm (10).

26. The robot arm (10) according to claim 24, characterized in that
the cover (66) has at least one sensor for detecting a collision of the robot arm (10).
